(19) United States
(12) Patent Application Publication
(10) Pub. No.: US 2026/0202097 A1
(43) Pub. Date: Jul. 16, 2026

(54) Valve Assemblies for Water Heating Systems

(71) Applicant: Rheem Manufacturing Company, Atlanta, GA (US)

(72) Inventors: Cameron Joseph Wright, Indianapolis, IN (US); John Relman Bohlen, Solon, OH (US); Matthew Richard Fehlner, Berea, OH (US); Matthew Vern Force, Bath, OH (US)

(21) Appl. No.: 19/450,436

(22) Filed: Jan. 15, 2026

Related U.S. Application Data
(60) Provisional application No. 63/746,066, filed on Jan. 16, 2025.

(51) Int. Cl. F24H 15/315; F16K 11/074; F16K 31/04; F16K 37/00; F24H 9/13; F24H 15/215; F24H 15/219; F24H 15/225; F24H 15/281

(52) U.S. Cl. CPC F24H 15/315; F16K 11/074; F16K 31/042; F16K 37/0041; F16K 37/005; F24H 9/136; F24H 15/215; F24H 15/219; F24H 15/225; F24H 15/281

(57) ABSTRACT

A valve including an inlet port, a valve stack and an actuator assembly is disclosed. The inlet port receives a supply of cold water, and the valve stack receives the cold water from the inlet port. The valve stack includes a first disc and a second disc in contact with each other. The first disc is configured to axially rotate relative to the second disc. The valve stack further includes a shaft connected to the first disc. The actuator assembly includes an actuator connected to the first disc via the shaft. The actuator is configured to cause an axial rotation of the first disc relative to the second disc. The valve stack is configured to control a flow of cold water to first and second external components based on a position of the first disc relative to the second disc when the first disc is axially rotated.

### CROSS-REFERENCED TO RELATED APPLICATIONS

The present application claims priority to and the benefit of U.S. provisional application No. 63/746,066, filed Jan. 16, 2025, which is hereby incorporated by reference in its entirety.

### FIELD

The present disclosure relates to valve assemblies for water heating systems and more specifically to valve assemblies including mixing and shut-off combinational valves and mixers connected via flexible shunts.

### BACKGROUND

Water heaters are generally used to provide a supply of heated water in a variety of applications, including residential, commercial, and industrial applications. A tank based water heater typically includes a storage tank that stores water that is heated by a heating source. The hot water stored in the storage tank is output via an outlet port of the water heater. A conventional water heater also includes a mixing valve that mixes/blends cold water with the hot water output from the storage tank to increase the capacity of the water heating system and ensure that the outlet water is at an optimal water temperature.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a block diagram of an example water heating system and a valve assembly of the water heating system in accordance with one or more embodiments of the present disclosure.

FIG. 2 depicts an internal cross-sectional view of a valve and a mixer of a valve assembly in accordance with one or more embodiments of the present disclosure.

FIG. 3 depicts an internal cross-sectional view of a valve stack of a valve in accordance with one or more embodiments of the present disclosure.

FIG. 4 depicts example top views of a valve stack of a valve in different operating states in accordance with one or more embodiments of the present disclosure.

FIG. 5 depicts a view of a disassembled actuator assembly of a valve assembly in accordance with one or more embodiments of the present disclosure.

FIG. 6 depicts a first isometric view of a valve with an actuator removed in accordance with one or more embodiments of the present disclosure.

FIG. 7 depicts a second isometric view of a valve with a bracket removed in accordance with one or more embodiments of the present disclosure.

FIG. 8 depicts a third isometric view of a valve with a drive spline removed in accordance with one or more embodiments of the present disclosure.

FIG. 9 depicts a top isometric view of a valve stack in accordance with one or more embodiments of the present disclosure.

FIG. 10 depicts a top isometric view of a shell of a valve stack in accordance with one or more embodiments of the present disclosure.

FIG. 11 depicts an isometric view showing one or more components of an actuator assembly and a valve stack of a valve in accordance with one or more embodiments of the present disclosure.

FIG. 12 depicts a view of an actuator being removed from an actuator assembly in accordance with one or more embodiments of the present disclosure.

FIG. 13 depicts a view of a combined valve stack and actuator assembly structure being removed from a valve body in accordance with one or more embodiments of the present disclosure.

FIG. 14 depicts a block diagram of a controller of a water heating system in accordance with one or more embodiments of the present disclosure.

FIG. 15 depicts a flow diagram of a first method to make a valve assembly of a water heating system in accordance with one or more embodiments of the present disclosure.

FIG. 16 depicts a flow diagram of a second method for servicing an actuator of a valve assembly in accordance with one or more embodiments of the present disclosure.

FIG. 17 depicts a flow diagram of a third method for servicing a combined valve stack and actuator assembly structure in accordance with one or more embodiments of the present disclosure.

### DETAILED DESCRIPTION

The present disclosure is directed to a water heating system (“system”) that may include a water tank or a storage tank and a valve assembly. The valve assembly may include a mixing and shut-off combinational valve (“valve”) and a mixing tee or mixer, which may be connected to each other via a flexible shunt or tube. The valve may include an inlet port that may be configured to receive a supply of cold water (e.g., from a utility water source). The valve may be connected to the “cold side” of the system (i.e., to the inlet point of the system that supplies cold water to the valve). The valve may be configured to either enable the flow of cold water received from the inlet port to the water tank and/or the mixer, or completely shut-off the flow of cold water to both the water tank and the mixer, based on an operating state in which the valve may be operating.

The water tank may be configured to receive the supply of cold water from the valve and heat the received water (via a heating source of the system). The water tank may not directly receive the supply of cold water from the utility water source and may instead receive the cold water via the valve. The water tank may be configured to supply the hot water stored in the water tank to the mixer.

The mixer may be in fluid communication with the water tank and the valve. The mixer may be configured to receive the hot water from the water tank and the cold water from the valve (via the shunt). The mixer may not receive the supply of cold water directly from the utility water source but may instead receive the cold water via the valve. Since the mixer receives the hot water from the water tank, the mixer is connected to the “hot side” of the system. The mixer may be configured to mix/blend the hot water received from the water tank and the cold water received from the valve and output a “blended” water to an outlet port of the mixer. A system user may use the water output from the outlet port for various residential, commercial, or industrial applications.

The valve may be configured to operate in a plurality of operating states, based on a plurality of parameters including, but not limited to, a temperature of hot water (“hot water temperature”) stored in the water tank, a temperature of water (“blended water temperature”) output by the mixer, a temperature of cold water (“cold water temperature”) received by the valve via the inlet port, a desired water temperature set by the system user, presence of water leak in the water tank, and/or the like. Based on an operating state in which the valve may be operating, the valve may either shut-off the supply of cold water to both the mixer and the water tank or enable the flow of cold water to the mixer and/or the water tank, as described below.

In some aspects, the valve may include a valve stack and an actuator assembly that may be connected to each other. The actuator assembly may include an actuator that may be removably connected with the actuator assembly, which may enable a service operator to conveniently service or remove the actuator from the valve (e.g., when the actuator may be faulty) without having to remove the entire valve from the system. In some aspects, the system operator may remove the actuator from the valve without having to use any external tools (e.g., wrenches, pliers, ratchet, etc.). Stated another way, the system operator may remove the actuator from the valve in a “tool-less” manner. In further aspects, the system operator may remove the entire valve (i.e., the combined structure of the valve stack and the actuator assembly) from the system in a tool-less manner (without having to access other system components or cutting the plumbing at the user's home), when the system operator requires to service one or more valve components.

The valve stack may be configured to receive the cold water from the inlet port and may include a plurality of components, including, but not limited to, an upper or a first disc, a lower disc or a second disc, a shaft, and/or the like. The upper disc may be disposed over the lower disc in the valve stack, and a bottom planar surface of the upper disc may contact a top planar surface of the lower disc. In an exemplary aspect, the upper disc may be semi-circular in shape, and the lower disc may be circular in shape. Both the upper and lower discs may have equivalent diameters.

The shaft may be attached to the upper disc and may be configured to enable axial rotation of the upper disc on the lower disc. The lower disc may be stationary in the valve stack, and the upper disc may rotate over the lower disc based on the torque applied to the upper disc via the shaft. In some aspects, the lower disc may include a first through-hole and a second through-hole. The first through-hole may be connected with the mixer via one or more conduits, the shunt, etc. Similarly, the second through-hole may be connected with the water tank via one or more conduits, a tank adapter, etc. As the upper disc rotates over the lower disc, the first and/or second through-holes may get exposed or blocked by the semi-circular body of the upper disc. In some aspects, the first and second through-holes (i.e., the “openings” in the valve) are large so as to avoid clogs/blockage due to scaling or debris in the water.

During operation, the cold water may be received on the top surface of the upper disc from the inlet port. Depending on the operating state in which the valve is required to operate, the shaft may axially rotate the upper disc on the lower disc so that the first and/or second through-holes may get exposed to the incoming cold water, or both the first and second through-holes may get blocked. For example, when the valve is required to operate in a first operating state where the cold water received from the inlet port should be transferred fully (or entirely) to the water tank, the shaft may rotate the upper disc such that the second through-hole may be fully exposed to the incoming cold water and the first through-hole may be completely blocked.

Similarly, when the valve is required to operate in a second operating state where the cold water received from the inlet port should be transferred partially to the water tank and partially to the mixer, the shaft may rotate the upper disc such that the first and second through-holes may be partially exposed to the incoming cold water.

Further, when the valve is required to operate in a third operating state where the cold water received from the inlet port should be transferred fully (or entirely) to the mixer, the shaft may rotate the upper disc such that the first through-hole may be fully exposed to the incoming cold water and the second through-hole may be completely blocked.

Furthermore, when the valve is required to operate in a fourth operating state where the cold water received from the inlet port should be completely shut-off from entering both the water tank and the mixer, the shaft may rotate the upper disc such that both the first and second through-holes may be fully blocked from the incoming cold water.

The actuator assembly may include an actuator (which may be, e.g., a motor) that may be connected with the shaft and configured to cause the axial rotation of the shaft (and hence cause the axial rotation of the upper disc on the lower disc) based on command signals received from a controller of the water heating system. The controller may be communicatively coupled with a plurality of temperature sensors included in the valve, the mixer, and the water tank and a leak detector of the system (that may be configured to detect water leak in the water tank). The controller may generate and transmit command signals to the actuator to cause axial rotation of the upper disc on the lower disc via the shaft (and hence change the operating state of the valve) based on the inputs obtained from the temperature sensors and the leak detector.

For example, the controller may cause the valve to operate in the fourth operating state when the inputs from the leak detector indicate a water leak in the water tank. Further, the controller may cause the valve to operate in the first, second, or third operating state based on the hot water temperature (as detected by a temperature sensor installed in the water tank), the cold water temperature (as detected by a temperature sensor installed in the valve), the blended water temperature (as detected by a temperature sensor installed in the mixer), and the desired water temperature (that may be set by the system user) when there is no water leak in the water tank.

It may appreciated that since a mixing valve is typically disposed at the “hot side” of a conventional water heating system (e.g., at a point where the hot water from the water tank mixes with the cold water), the mixing valve of a conventional water heating system is not equipped to completely shut-off the supply of cold water from the utility water source into the water tank in the event of a water leakage. Therefore, in some cases, a conventional water heating system may require two separate valves to operate optimally: one valve for mixing hot and cold water and a second valve for shutting off the supply of cold water in the event of a water leakage. On the other hand, in accordance with the present disclosure, since the valve is disposed at the “cold side” of the system and controls the flow of cold water towards the mixer and the water tank simultaneously, the valve, according to the present disclosure, is able to perform the operations of water mixing and shutting off the water supply within a single valve.

Further, since the valve of the present disclosure, including the “moving parts” such as the rotating upper disc, is disposed on the “cold side” of the system and not on the “hot side,” the valve experiences considerably less scaling and structural degradation over time.

The present disclosure discloses a water heating system in which a mixing and shut-off combination valve of a valve assembly is disposed at the “cold side” of the system. Since the valve is disposed on the system's cold side, the valve may experience considerably less scaling and structural degradation over time, as compared to a mixing valve in a conventional heating system which is installed at the “hot side” of the system. Further, since the valve is disposed on the system's cold side, the valve can effectively function as a mixing valve as well as a shut-off valve, and the system is not required to have two separate valves for mixing and shutting-off operations. Furthermore, the system enables a system operator (e.g., a plumber or a system user) to conveniently remove and/or service one or more valve components (e.g., the actuator) in a tool-less manner, without having to remove the entire valve from the system, disconnecting the water heater from the home plumbing, or cutting any copper/plumbing pipes.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of a valve assembly of a water heating system. The present disclosure, however, is not so limited, and can be applicable in other contexts. Accordingly, when the present disclosure is described in the context of a valve assembly of a water heating system, it will be understood that other implementations can take the place of those referred to.

Although the term “water” is used throughout this specification, it is to be understood that other fluids may take the place of the term “water” as used herein. Therefore, although described as a valve assembly of a water heating system, it is to be understood that the system and method described herein can apply to fluids other than water. Further, it is also to be understood that the term “water” can replace the term “fluid” as used herein unless the context clearly dictates otherwise. More so, the terms “cold” and “hot” are relative and may mean different degrees of varying temperatures and ranges based on the context. Thus, the terms “cold” and “hot” should not be limited to any temperature or temperature range.

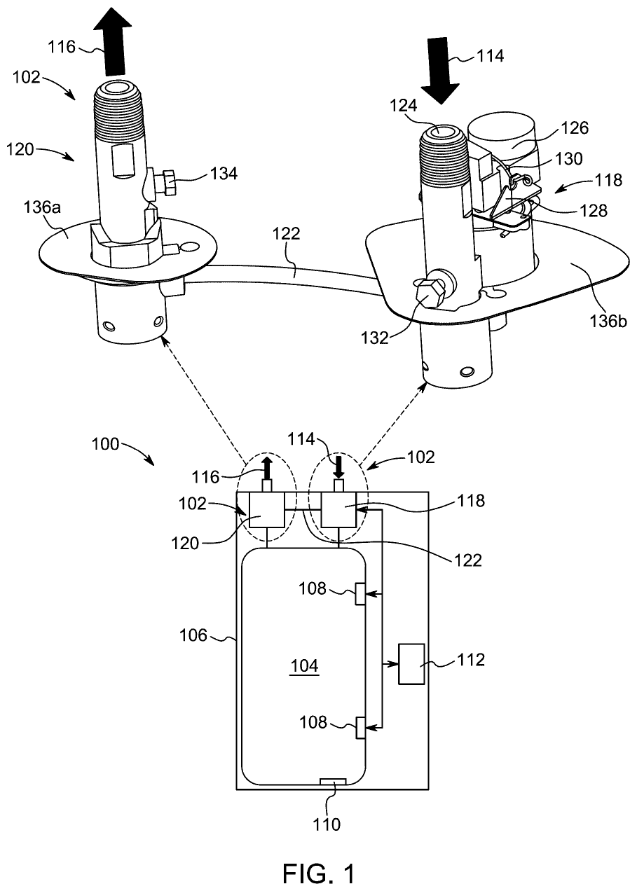

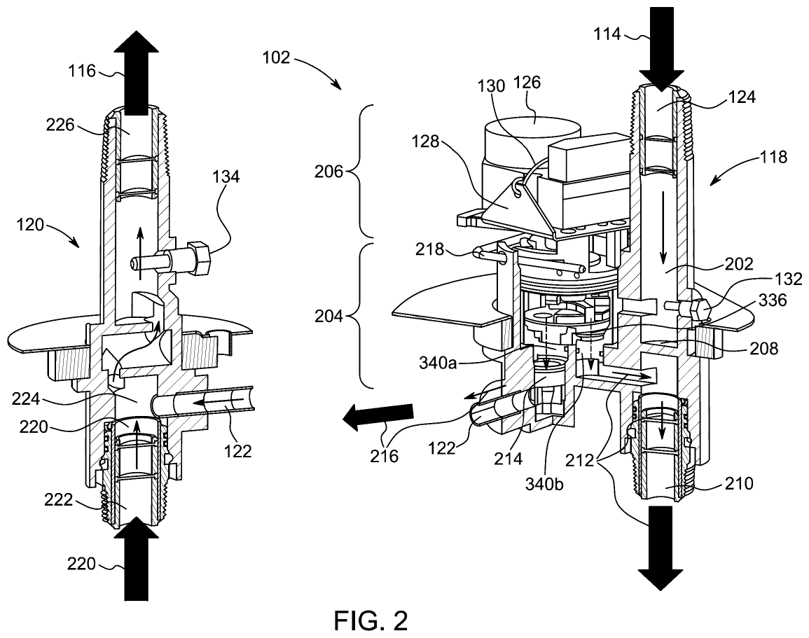

Turning now to the drawings, FIG. 1 depicts a block diagram of an example water heating system 100 (or water heater 100 or system 100) and a view of a valve assembly 102 of the system 100 in accordance with one or more embodiments of the present disclosure. While describing FIG. 1, references will be made to FIGS. 2-13.

The system 100 may include a plurality of components including, but not limited to, the valve assembly 102, a storage tank 104 (or a water tank), a housing 106, one or more first temperature sensors 108 (or first temperature sensor 108), a leak detector 110, a controller 112, and/or the like. The system 100 may include a plurality of additional components which are not shown in FIG. 1 for the sake of simplicity and conciseness (e.g., one or more heating sources configured to heat the water stored in the storage tank 104, heat exchangers or coils, and/or the like). The example depiction of the system 100 in FIG. 1 should not be construed as limiting.

The storage tank 104 may be configured to store water, which may be heated by the heating source(s) described above. The heating source(s) may be, for example, a gas burner, an electrical heating element, a heat pump, solar, and/or the like. The heating source(s) may heat the water stored in the storage tank 104 via one or more heating elements (e.g., heat exchanger coils, not shown) that may be disposed in an interior portion of the storage tank 104 or wrapped around an exterior surface of the storage tank 104. Alternatively, the heating source(s) may heat the water stored in the storage tank 104 via any other known means, without departing from the scope of the present disclosure.

The storage tank 104 may be of any size, shape, or configuration based on the water heating system application. For example, the storage tank 104 may be sized for common residential use or for commercial or industrial use that may require greater amounts of heated water. Furthermore, the storage tank 104 may be made of any suitable material for storing and heating water, including copper, carbon steel, stainless steel, ceramics, polymers, composites, or any other suitable material. The storage tank 104 may also be treated or lined with a coating to prevent corrosion and leakage. A suitable treating or coating will be capable of withstanding the temperature and pressure of the system 100 and may include, as non-limiting examples, glass enameling, galvanizing, thermosetting resin-bonded lining materials, thermoplastic coating materials, cement coating, or any other suitable treating or coating for the application.

The housing 106 may be configured to enclose one or more system 100 components and protect them from ambient environment. For example, as shown in FIG. 1, the storage tank 104, the controller 112, one or more components of the valve assembly 102 (e.g., one or more valve components that are disposed under foam dams 136a, 136b, which are described later in the description below), the first temperature sensors 108, and/or the like may be located inside the housing 106 and hence enclosed by the housing 106. The example depiction of the system 100 shown in FIG. 1 should not be construed as limiting, and one or more system 100 components shown to be located inside the housing 106 in FIG. 1 may be located outside the housing 106 in some embodiments, without departing from the scope of the present disclosure.

In an exemplary aspect, the first temperature sensors 108 may be disposed along a length of the interior surface of the storage tank 104. Although FIG. 1 depicts two first temperature sensors 108, the system 100 may include more or less than two first temperature sensors 108. The first temperature sensor 108 may be configured to determine a water temperature (or “hot water temperature”) of the hot water stored in the storage tank 104. The first temperature sensor 108 may be communicatively coupled with the controller 112 and may share inputs associated with the hot water temperature with the controller 112 continuously or at a predefined frequency.

In certain embodiments, the leak detector 110 may be disposed on the storage tank 104 (e.g., at the interior surface or an exterior surface of the storage tank 104) or spaced apart from the storage tank 104 and may be configured to detect a water leak in the storage tank 104. Although FIG. 1 depicts that the leak detector 110 is disposed at a bottom portion of the storage tank 104, the present disclosure is not limited to such an arrangement. The leak detector 110 may be located anywhere on or in proximity to the storage tank 104, without departing from the scope of the present disclosure. In further aspects, in addition to detecting the water leak in the storage tank 104, in certain instances, the leak detector 110 may also be configured to detect water leak in other components of the system 100. Similar to the first temperature sensor 108, the leak detector 110 may also be communicatively coupled with the controller 112 and may share inputs associated with the water leak in the storage tank 104 (or other components of the system 100) with the controller 112 continuously or at a predefined frequency.

The controller 112 may be configured to control operation of the valve assembly 102 based on inputs obtaining from the first temperature sensor 108, the leak detector 110, and one or more temperature sensors included in the valve assembly 102, as described in the description later below.

The valve assembly 102 may be configured to receive a supply of cold water 114 (e.g., from a utility water source) and output water 116 at a desired water temperature (that may be set by a system user), which may be used by the system user for various residential, commercial or industrial applications. In some aspects, the various openings in the valve assembly 102 through which the water flows are large so as to avoid clogs/blockage due to scaling or debris in the water. Although FIG. 1 depicts the valve assembly 102 being disposed in proximity to a top portion of the storage tank 104/housing 106, the present disclosure is not limited to such an arrangement. In some aspects, the valve assembly 102 may be disposed in proximity to a side portion of the storage tank 104/housing 106, without departing from the scope of the present disclosure.

The valve assembly 102 may include a plurality of components including, but not limited to, a valve 118, a mixing tee or a mixer 120, a connector or a shunt 122, and/or the like. The valve 118 may be in fluid communication with the mixer 120 and the storage tank 104. In some aspects, the valve 118 may be configured to receive the supply of cold water 114 and control a flow of cold water to the mixer 120 and the storage tank 104 based on an operating state in which the valve 118 may be operating. For example, the valve 118 may transfer the cold water 114 fully to the storage tank 104 when the valve 118 is operating in a first operating state, partially to the storage tank 104 and partially to the mixer 120 when the valve 118 is operating in a second operating state, fully to the mixer 120 when the valve 118 is operating in a third operating state, or completely shut-off the supply/flow of cold water to both the storage tank 104 and the mixer 120 when the valve 118 is operating in a fourth operating state. In any operating state, the valve 118 does not receive the hot water from the storage tank 104. The valve 118 is only configured to transfer the cold water to the storage tank 104 and/or the mixer 1120, or completely shut-off the supply of cold water to both the storage tank 104 and the mixer 120.

In some aspects, the valve 118 may be connected with the mixer 120 via the shunt 122, which may be made of a flexible material or a rigid, non-flexible material. In an exemplary aspect, the shunt 122 may be made of copper, polyethylene (e.g., high density polyethylene), and/or the like. The mixer 120 may be configured to receive the cold water from the valve 118 (via the shunt 122) and the hot water from the storage tank 104, blend the hot and cold water, and output the blended water 116 at the desired water temperature. Structural details of the valve 118 and the mixer 120 are described below, in conjunction with FIGS. 2-13.

In some aspects, the valve 118 may include an inlet port 124, an inlet water conduit 202 (as shown in FIG. 2), a valve stack 204, an actuator assembly 206, and/or the like, as shown in FIGS. 1 and 2. The inlet port 124 may be configured to receive the supply of cold water 114 and transfer the cold water 114 to the inlet water conduit 202. In an exemplary aspect, both the inlet port 124 and the inlet water conduit 202 may be cylindrical in shape and may have similar diameters in a range of 0.5 to 1 inch. The inlet water conduit 202 may be configured to transfer the cold water 114 to the valve stack 204. In some aspects, the inlet water conduit 202 may include one or more barrier layers (e.g., shown as a barrier layer 208 in FIG. 2) that may enable the cold water 114 to get diverted to the valve stack 204 and not to any other component of the valve assembly 102 or the system 100.

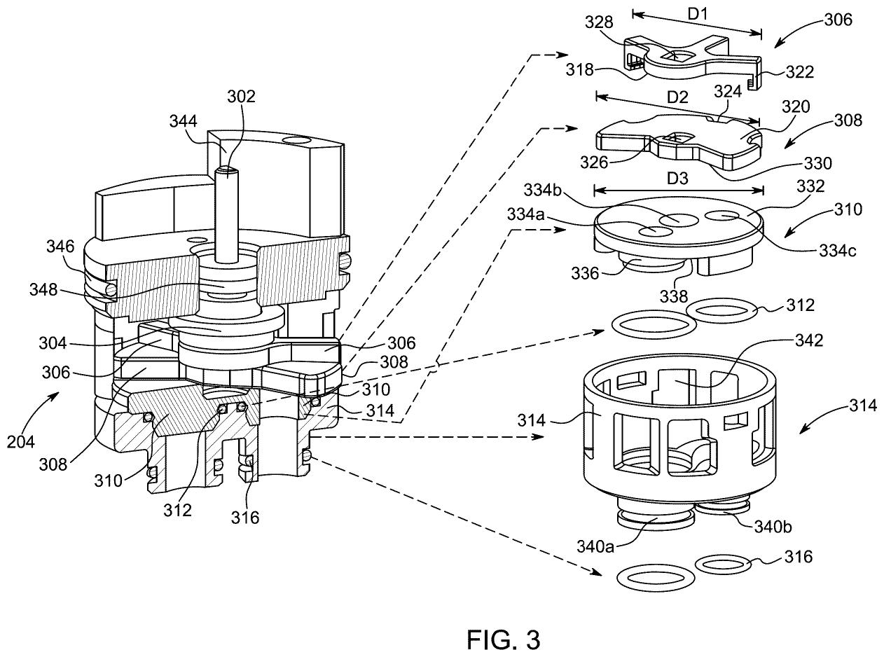

The valve stack 204 may be configured to receive the cold water 114 from the inlet port 124 via the inlet water conduit 202. The valve stack 204 may include a plurality of components that may enable the valve stack 204 to control/regulate the flow of cold water 114 to the mixer 120 and the storage tank 104 based on the operating state of the valve 118. An interior cross-sectional view of the valve stack 204 is depicted in FIG. 3.

In an exemplary aspect, the valve stack 204 may include a shaft 302, a washer 304, a retainer disc 306, an upper disc 308 (or a first disc 308), a lower disc 310 (or a second disc 310), one or more face seals 312, a shell 314, one or more radial seals 316, and/or the like. The retainer disc 306 may be connected/attached to the upper disc 308 such that a bottom planar surface 318 of the retainer disc 306 may touch a top planar surface 320 of the upper disc 308. Stated another way, in the valve stack 204, the retainer disc 306 may be disposed above the upper disc 308 and in contact with the upper disc 308. In some aspects, the retainer disc 306 may include one or more protruding arms 322 (with a bent hook at the end of each protruding arm 322) and the upper disc 308 may be include one or more cut-outs 324 formed on a periphery of the upper disc 308. A count of the protruding arms 322 may be equivalent to a count of the cut-outs 324, and the protruding arms 322 may have shapes complimentary to the shapes of the cut-outs 324. The retainer disc 306 may be connected/attached to the upper disc 308 when the protruding arms 322 may be aligned and clamped with the cut-outs 324.

In some aspects, a diameter “D1” of the retainer disc 306 may be equivalent to a diameter “D2” of the upper disc 308, which may be in a range of one to three inches. Further, both the retainer disc 306 and the upper disc 308 may have equivalent thicknesses, which may be in a range of 0.2 to 0.75 inches.

In an exemplary aspect, as shown in FIG. 3, the upper disc 308 may be semi-circular in shape and may include a cavity 326 disposed at a center portion/point of the upper disc 308. Further, the retainer disc 306 may include a first through-hole 328 that may be disposed at a center portion/point of the retainer disc 306. When the retainer disc 306 may be clamped/attached with the upper disc 308, the cavity 326 may be aligned with the first through-hole 328, such that a longer integrated cavity may be formed at a center point of the combined structure of the retainer disc 306 and the upper disc 308. In one exemplary aspect, the cavity 326 and the first through-hole 328 may be square in shape, having equivalent dimensions of the edge in a range of 0.05-0.25 inches. In another exemplary aspect, the cavity 326 and the first through-hole 328 may be circular in shape, having equivalent diameters in a range of 0.05-0.25 inches. In an alternative aspect, the cavity 326 may instead be a through-hole. In yet another alternative aspect, the first through-hole 328 may instead be a cavity.

Further, a bottom planar surface 330 of the upper disc 308 may contact a top planar surface 332 of the lower disc 310. In an exemplary aspect, the lower disc 310 may be circular in shape and may have a diameter “D3” that may be equivalent to the diameter “D2.” Further, the thickness of the lower disc 310 may be equivalent to the thickness of the upper disc 308.

The lower disc 310 may include one or more second through-holes that may be square, rectangular, or circular in shape. In the exemplary aspect depicted in FIG. 3, the lower disc 310 may include three through-holes 334a, 334b, 334c, which are circular in shape. Each second through-hole 334a, 334b, 334c may have same or different diameters in a range of 0.25 to 1.25 inches. In some aspects, the through-hole 334b may be disposed at a center point of the lower disc 310. In one alternative embodiment, the through-hole 334b may instead be a cavity that may be open at the top planar surface 332 but closed at a bottom surface. In some aspects, when the bottom planar surface 330 of the upper disc 308 contacts the top planar surface 332 of the lower disc 310, the first through-hole 328, the cavity 326 and the through-hole 334b may be aligned in a straight line.

The through-holes 334a and 334c may be disposed on the left and right sides of the through-hole 334b, and the center points of the through-holes 334a, 334b, and 334c may not be in a straight line. Specifically, in one exemplary aspect, the center points of the through-holes 334a, 334b, and 334c may form a “V-shape.” Further, each through-hole 334a, 334c may be connected to a conduit 336 at a bottom planar surface 338 of the lower disc 310. The conduit 336 may be used to transfer the cold water to the mixer 120 and the storage tank 104, as described later in the description below.

The upper disc 308 may be configured to axially rotate relative to the lower disc 310 about the axis of the first through-hole 328, the cavity 326 and the through-hole 334b. Stated another way, the upper disc 308 may be configured to axially rotate relative to the lower disc 310 about the center points of the upper disc 308 and the lower disc 310. The lower disc 310 may be a stationary disc, and the upper disc 308 may be configured to rotate on top of the lower disc 310 (while still contacting the lower disc 310). In some aspects, the shaft 302 may be connected to the upper disc 308 via the retainer disc 306 and the washer 304 (which ensures secure and water-tight connection between the shaft 302 and the retainer disc 306) and may be configured to cause the axial rotation of the upper disc 308 relative to the lower disc 310. Specifically, the shaft 302 may rotate (based on actuation from the actuator assembly 206, as described later below) and transfer the torque to the retainer disc 306, which itself may rotate when the shaft 302 rotates. The retainer disc 306 may in turn transfer the torque to the upper disc 308 via the arms 322, which may cause the axial rotation of the upper disc 308 on the lower disc 310. The rotation of the upper disc 308 on the lower disc 310 may cause the through-holes 334a and 334c to get blocked or get opened (fully or partially) causing the cold water received in the valve stack 204 from the inlet port 124 to get transferred to the mixer 120, the storage tank 104, to both or to none, as described below.

In certain embodiments, the discs disclosed herein may be ceramics. In some instances, a grease or other lubricant may be disposed between the discs (e.g., between the upper disc 308 and the lower disc 310) to facilitate movement therebetween. In some aspects, the upper disc 308 may be preloaded against the lower disc 310. That is, the upper disc 308 may be pressed against the lower disc 310. However, the force between the upper disc 308 against the lower disc 310 should not be so great as to prohibit movement therebetween.

In some aspects, the cold water received in the valve stack 204 from the inlet port 124 may be received on the top planar surface 320 of the upper disc 308 (directly or via the retainer disc 306). Further, the conduit 336 underneath the through-hole 334a may be configured to transfer the cold water passing through the through-hole 334a to the mixer 120, and the conduit 336 underneath the through-hole 334c may be configured to transfer the cold water passing through the through-hole 334c to the storage tank 104.

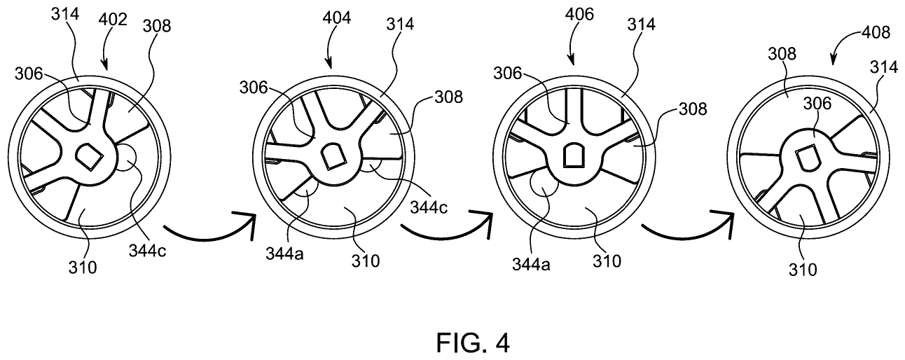

When the valve 118 is operating (or is required to operate) in the first operating state (i.e., when the valve 118 is transferring the cold water 114 fully to the storage tank 104), the shaft 302 may axially rotate the upper disc 308 on the lower disc 310 such that the through-hole 334c may be exposed to the incoming cold water entering the valve stack 204 and the through-hole 334a may be blocked by the body of the upper disc 308, as shown in a view 402 of FIG. 4. In this configuration, the conduit 336 underneath the through-hole 334c may receive all the cold water entering the valve stack 204 from the inlet port 124 and transfer the cold water fully to the storage tank 104 (and no cold water may be transferred to the mixer 120).

When the valve 118 is operating (or is required to operate) in the second operating state (i.e., when the valve 118 is transferring the cold water 114 partially to the storage tank 104 and partially to the mixer 120), the shaft 302 may axially rotate the upper disc 308 on the lower disc 310 such that both the through-holes 334a and 334c may be partially exposed to the incoming cold water entering the valve stack 204, as shown in a view 404 of FIG. 4. In this configuration, both the conduits 336 underneath the through-holes 334a and 334c may partially receive the cold water entering the valve stack 204 from the inlet port 124 and transfer the cold water partially to the storage tank 104 and the mixer 120. In some aspects, the “opening percentage” of each through-holes 334a and 334c may be based on a plurality of parameters, e.g., the hot water temperature of the hot water stored in the storage tank 104, the desired water temperature, the cold water temperature, and/or the like, as described later in the description below.

When the valve 118 is operating (or is required to operate) in the third operating state (i.e., when the valve 118 is transferring the cold water 114 fully to the mixer 120), the shaft 302 may axially rotate the upper disc 308 on the lower disc 310 such that the through-hole 334a may be exposed to the incoming cold water entering the valve stack 204 and the through-hole 334c may be blocked by the body of the upper disc 308, as shown in a view 406 of FIG. 4. In this configuration, the conduit 336 underneath the through-hole 334a may receive all the cold water entering the valve stack 204 from the inlet port 124 and transfer the cold water fully to the mixer 120 (and no cold water may be transferred to the storage tank 104).

When the valve 118 is operating (or is required to operate) in the fourth operating state (i.e., when the valve 118 completely shuts-off the flow of cold water 114 to both the mixer 120 and the storage tank 104), the shaft 302 may axially rotate the upper disc 308 on the lower disc 310 such that both the through-holes 334a and 334c may be blocked by the body of the upper disc 308, as shown in a view 408 of FIG. 4. In this configuration, the conduits 336 underneath the through-holes 334a, 334c may not receive any cold water entering the valve stack 204 from the inlet port 124, and thus the transfer of cold water to both the mixer 120 and the storage tank 104 may be shut-off. The valve 118 may operate in the fourth operating state when there may be a water leak in the storage tank 104 (or any other component of the system 100) or the system 100/valve assembly 102 may be undergoing servicing or maintenance.

In some aspects, the through-holes described above may be large so as to avoid clogs/blockage due to scaling or debris in the water.

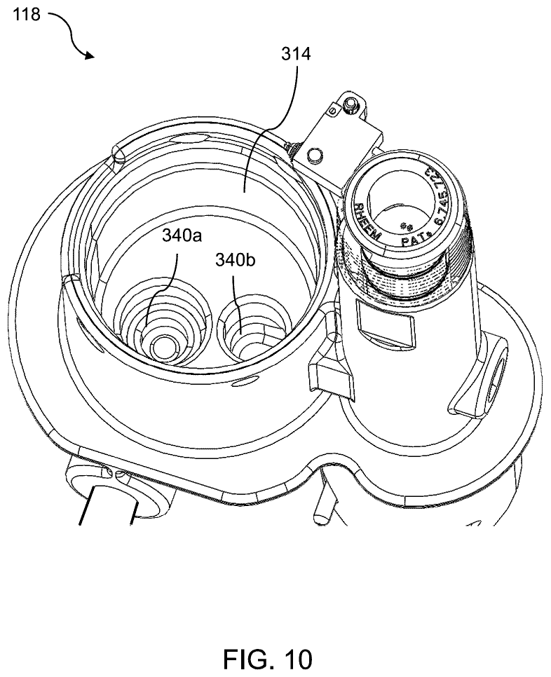

As described above, the valve stack 204 may also include the shell 314. In an exemplary aspect, the shell 314 may have a hollow cylindrical body having an open top portion and two hollow conduits 340a, 340b at a bottom portion/surface. A top isometric view of the hollow conduits 340a, 340b is depicted in FIG. 10. The shell 314 may have a diameter equivalent to the diameters of the upper and lower discs 308, 310 and may be configured to enclose the peripheries of the upper and lower discs 308, 310 in the hollow cylindrical body (along with the retainer disc 306). When the upper and lower discs 308, 310 are enclosed in the hollow cylindrical body of the shell 314, the conduit 336 underneath the through-hole 334a may be aligned and connected with the hollow conduit 340a via a face seal 312 (which may prevent any water leakage), and the conduit 336 underneath the through-hole 334c may be aligned and connected with the hollow conduit 340b via another face seal 312. In this manner, the cold water entering the conduits 336 may enter the respective hollow conduits 340a, 340b of the shell 314.

The bottom portions of the hollow conduits 340a, 340b may be connected with the radial seals 316 and configured to divert the flow of cold water received from the conduits 336 to the mixer 120 and the storage tank 104. Specifically, the hollow conduit 340b may transfer the cold water received from the conduit 336 underneath the through-hole 334c to the storage tank 104 via a storage tank adapter 210, as shown by arrows 212 in FIG. 2. Further, the hollow conduit 340a may transfer the cold water received from the conduit 336 underneath the through-hole 334a to the mixer 120 via a shunt check valve 214 and the shunt 122, as shown by arrows 216 in FIG. 2.

In some aspects, apart from enabling the flow of cold water to the mixer 120 and the storage tank 104 as described above, the shell 314 may provide additional advantages. For example, the shell 314 may be configured to distribute the flow of cold water received from the inlet port 124 into the “diverting chamber” of the valve stack 204 (i.e., the volume including the retainer disc 306, the upper disc 308 and the lower disc 310) via one or more cut-outs 342 present on the walls of the shell 314. The cut-outs 342 may have any shape or dimensions, depending on the shape and dimensions of the valve stack 204, and/or the system dimensions. In alternative aspects, the shell 314 may include a plurality of small through-holes on the walls (instead of the cut-outs 342), which may act as a filtration means to filter the cold water entering the diverting chamber from the inlet port 124. In some aspects, the upper disc 308 may receive the cold water from the inlet port 124 via the shell 314. Therefore, when the shell 314 includes the plurality of small through-holes on the walls, the cold water being received by the upper disc 308 may be filtered, and hence the water that may be diverted to the mixer 120 and/or the storage tank 104 may also be filtered/clean.

The shell 314 may be further configured to securely connect the valve stack 204 to the actuator assembly 206 via an actuator mount structure 344 (which may be part of the valve 118) shown in FIG. 3. Specifically, the shell 314 may be attached to a bottom portion of the actuator mount structure 344, and the actuator assembly 206 may be attached to a top portion of the actuator mount structure 344, and thus the actuator mount structure 344 may enable attachment/connection between the actuator assembly 206 and the valve stack 204.

Although the description above describes an aspect where the shell 314 is part of the valve stack 204, the present disclosure is not limited to such an aspect. In alternative aspects (not shown), the valve stack 204 may not include the shell 314 and may instead include a “central spindle” or any other similar structure that connects the valve stack 204 to the actuator assembly 206.

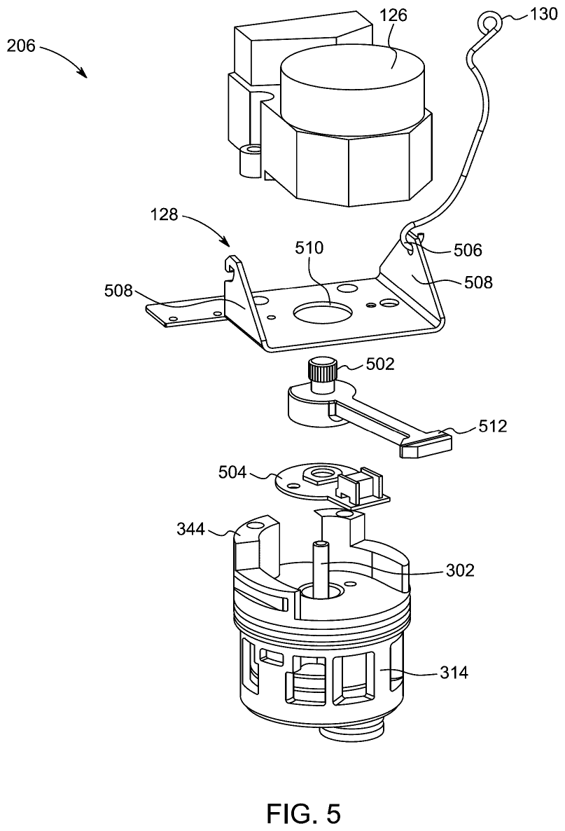

In some aspects, the actuator assembly 206 may include a plurality of components including, but not limited to, an actuator 126, a stamped bracket with screws 128 (or a bracket 128), a retainer clip 130 (or first removable connection means), a drive spline 502, a position sensor 504, and/or the like, as shown in FIGS. 1, 2 and 5. The actuator 126 may be a motor (e.g., a servo motor, a linear motor, etc.), which may be configured to be attached to the bracket 128 via the retainer clip 130. In some aspects, the retainer clip 130 may be wrapped around the actuator 126, and the two ends of the retainer clip 130 may be attached (shown as a connection 506 in FIG. 5) to the respective ends of the bracket 128 to enable attachment between the actuator 126 and the bracket 128. In some aspects, the retainer clip 130 enables removable connection of the actuator 126 with the bracket 128 (and hence with the actuator assembly 206).

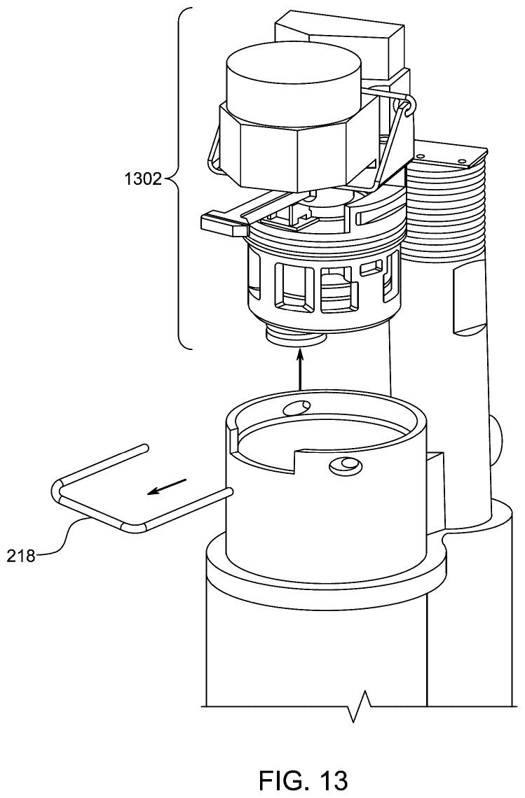

The bracket 128 may be configured to be attached to the valve stack 204 via the actuator mount structure 344. Specifically, the bracket 128 may be configured to be attached to the actuator mount structure 344 via one or more fastening means (e.g., screws), and the actuator mount structure 344 is attached to the valve stack 204 (e.g., the shell 314, as described above). In this manner, the bracket 128 may attach to the valve stack 204 via the actuator mount structure 344. When the bracket 128 (with the connected actuator 126) is attached to the valve stack 204 via the actuator mount structure 344, a “connected” structure of the valve stack 204 and the actuator assembly 206 may be formed (or a connected valve stack and actuator assembly structure 1302 may be formed, as shown in FIG. 13).

In an exemplary aspect, the bracket 128 may be a rectangular or square plate having dimensions (e.g., length and/or width) equivalent to the dimension of the shell 314 (or the upper and lower discs 308, 310). The bracket 128 may further include two sidewalls 508, which may be disposed at the edges of the bracket 128 that connect with the ends of the retainer clip 130, as shown in FIG. 5. The bracket 128 may further include a through-hole 510 disposed at a center position of the bracket 128, through which the drive spline 502 may connect with the actuator 126. The actuator 126 may be configured to be connected to the shaft 302 via the drive spline 502. Specifically, the actuator 126 may be connected to the drive spline 502, which in turn may be connected to the shaft 302 (e.g., to a top end of the shaft 302). Since the shaft 302 itself is connected to the upper disc 308 (via the retainer disc 306) and the actuator 126 is connected to the shaft 302 via the drive spline 502, it may be appreciated that the actuator 126 is connected to the upper disc 308 via the drive spline 502 and the shaft 302. Alternative to the drive spline 502, in some instances, the actuator 126 may be connected via any suitable interface, including but not limited to, an interference fit, a “D-shaped” shaft, a keyway with key, setscrews, etc. Any suitable connection may be used.

The actuator 126 may be communicatively coupled with the controller 112 and configured to cause the axial rotation of the upper disc 308 (specifically the retainer disc 306) relative to the lower disc 310 via the drive spline 502 and the shaft 302, based on command signals received from the controller 112. Specifically, based on the command signals received from the controller 112, the actuator 126 may cause the axial rotation of the drive spline 502, which may transfer the torque to the shaft 302, which in turn may transfer the torque to the retainer disc 306, which causes the axial rotation of the upper disc 308 relative to lower disc 310. As described above, the valve stack 204 may control/enable the flow of cold water 114 to the mixer 120 and/or the storage tank 104 based on a position of the upper disc 308 relative to the lower disc 310 when the upper disc 308 is rotated. Since the actuator 126 causes the axial rotation of the upper disc 308 relative to the lower disc 310 (and hence controls the position of the upper disc 308 on the lower disc 310) based on the command signals received from the controller 112, it may be appreciated that the actuator 126 controls/enables the flow of cold water 114 to the mixer 120 and/or the storage tank 104 based on the command signals received from the controller 112.

In some aspects, the drive spline 502 (and hence the actuator 126) may be connected with the shaft 302 via the position sensor 504. The position sensor 504 may be configured to detect a real-time axial position of the shaft 302. The position sensor 504 may be communicatively coupled with the controller 112 and may share inputs associated with the real-time axial position of the shaft 302 with the controller 112 continuously or at a predefined frequency. The position sensor 504 may be, for example, a linear position sensor, a rotary position sensor, a magnetic position sensor, a Hall Effect sensor, a potentiometer, and/or the like. The position sensor 504 may include any type of suitable position sensor. In some aspects, the position sensor 504 may be positioned at predetermined locations in the valve assembly 102. The controller 112 may use measurements from the position sensor 504 and the operation of the actuator 126 to determine the axial position of the shaft 302. Stated another way, the determination of the axial position of the shaft 302 may be made based on the measurements from the position sensor 504 in combination with the operation of the actuator 126. In some instances, the position sensor 504 and/or the PCB associated therewith may be part of a through hole component and not surface mounted in order to increase reliability of the sensor 504.

In further aspects, the drive spline 502 may include an override lever 512 using which a system operator may manually rotate the upper disc 308 on the lower disc 310 (i.e., change the operating state of the valve 118). In an exemplary aspect, the system operator may manually rotate the upper disc 308 on the lower disc 310 via the override lever 512 to change the valve's operating state to the fourth operating state (i.e., the “shut-off” state) when the actuator 126 may be malfunctioning, or when the system operator may be servicing the valve 118/system 100.

The valve 118 may further include a second temperature sensor 132 that may be configured to determine a temperature of the cold water 114 (or cold water temperature) entering the valve 118 from the inlet port 124. The second temperature sensor 132 may be communicatively coupled with the controller 112 and may share inputs associated with the cold water temperature with the controller 112 continuously or at a predefined frequency.

The valve 118 may further include an insertion clip 218 (or second removable connection means, which may be similar to the retainer clip 130) that may be configured to connect the actuator mount structure 344 with the body of the valve 118, as shown in FIG. 2. Specifically, when the valve stack 204 may be connected to the actuator assembly 206 via the actuator mount structure 344, the actuator mount structure 344 may be connected or retained to the body of the valve 118 via the insertion clip 218, thus connecting the “integrated unit” comprising the valve stack 204 and the actuator assembly 206 (i.e., the connected valve stack and actuator assembly structure 1302) to the body of the valve 118 (or “valve body”).

In an exemplary aspect, the insertion clip 218 may be a “U-shaped” clip, the ends of which may be inserted into through-holes present in the valve body. The arms of the U-shaped clip/insertion clip 218 may press against the actuator mount structure 344, thereby securing the actuator mount structure 344 (and hence the connected valve stack and actuator assembly structure 1302) inside the valve body.

It may be appreciated that connection via clips (e.g., the retainer clip 130 and/or the insertion clip 218) is secure and stable. Further, it is easy to connect and disconnect the components that are connected via the clips. For example, the system operator may easily insert the insertion clip 218 into the through-holes present in the valve body to attach the connected valve stack and actuator assembly structure 1302 to the valve body and similarly remove/pull out the insertion clip 218 from the through-holes present in the valve body to detach/disconnect or remove the connected valve stack and actuator assembly structure 1302 from the valve body. In this manner, the insertion clip 218 enables removable connection between the structure 1302 and the valve body. The process of connecting and disconnecting one or more valve assembly components via the clips is described later below.

As described above, the clips (e.g., the insertion clip 218) may be U-shaped clips. Other types of clips, e.g., c-clips, lock wires, clips like “hair pins,” etc. may also be used without departing from the scope of the present disclosure. In additional or alternative embodiments, the clips may be replaced with a stamped sheet-metal part (made from a variety of materials) that provides spring-retained positive lock. In this case, the system may not require or have “loose” clips.

In some aspects, the presence/usage of the clips described above facilitates the system operator (e.g., a plumber or a system user/customer) to conveniently remove and/or service one or more valve components in a tool-less manner (i.e., without having to use any external tools, e.g., wrenches, pliers, ratchet, etc.). For example, the retainer clip 130 enables the system operator to conveniently remove the actuator 126 from the actuator assembly 206 in a tool-less manner. As another example, the insertion clip 218 enables the system operator to remove the structure 1302 from the valve body in a tool-less manner. Further, the presence or usage of the clips facilitates the system operator to conveniently remove and/or service one or more valve components (e.g., one or more wetted moving parts of the valve) without having to cut into the plumbing of the home (e.g., cutting copper pipe and doing some brazing), or disconnecting the system 100 from the home plumbing. Specifically, the “removable” manner in which the components of the valve stack 204 and the actuator assembly 206 are connected enables the system operator to remove or service one or more valve components in a tool-less manner and without having to affect the home plumbing.

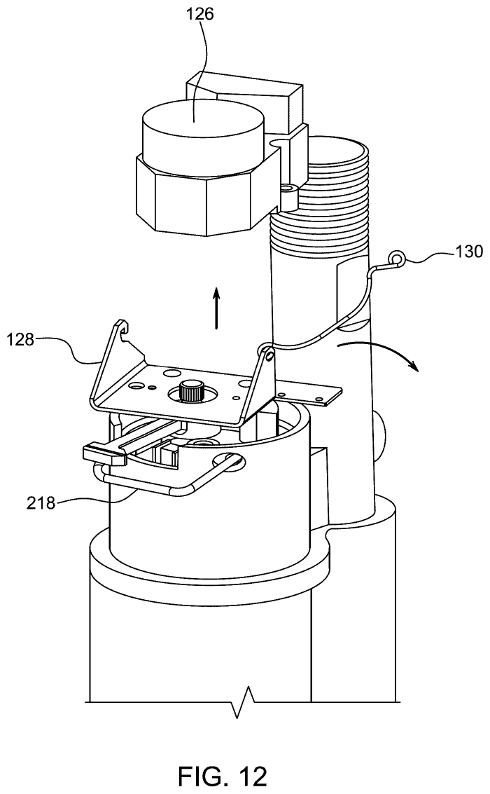

For example, as shown in FIG. 12, when the system operator requires to service or replace only the actuator 126 (e.g., when the actuator 126 may be malfunctioning), the system operator may remove or unwrap the retainer clip 130 from the bracket 128 to release the actuator 126, without having to remove the entire valve 118 from the system 100. Further, since the system operator may remove the actuator 126 just by unwrapping the retainer clip 130, the system operator may not require any external tool and may not require modification of the home plumbing in any manner to remove/service the actuator 126. In this manner, the valve assembly 102, as described in the present disclosure, enables tool-less removal and/or servicing of one or more valve components.

Similarly, as shown in FIG. 13, when the system operator requires to service other valve assembly components (e.g., the valve stack 204), the system operator may remove the insertion clip 218 from the valve body to release the connected valve stack and actuator assembly structure 1302, without having to remove the entire valve 118 from the system 100 or affecting the home plumbing. Once the connected valve stack and actuator assembly structure 1302 is removed, the system operator may conveniently service the valve stack 204 or any other component of the valve 118.

In some aspects, the valve stack components described above (e.g., the retainer disc 306, the upper disc 308, the lower disc 310, and the shell 314) may be made of plastic, rubber, metal, and/or any other similar material that can withstand the flow of cold water entering the valve stack 204. Further, one or more components of the actuator assembly 206 may also be made of plastic, metal or a combination thereof. Furthermore, the body of the valve 118 may be made of plastic, and the insertion clip 218 may be made of metal (e.g., copper, aluminum, and/or the like).

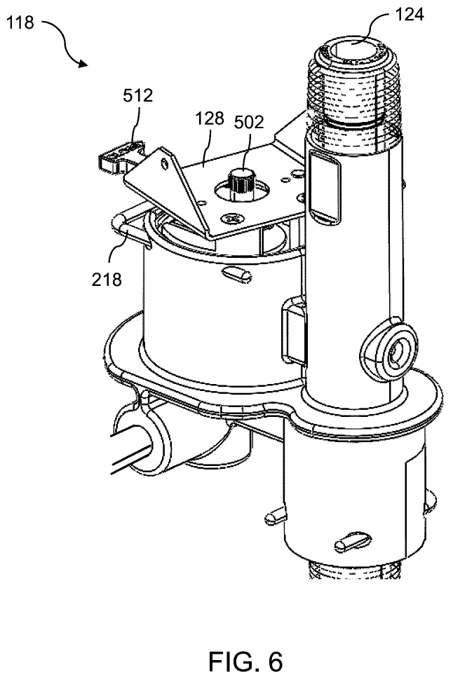

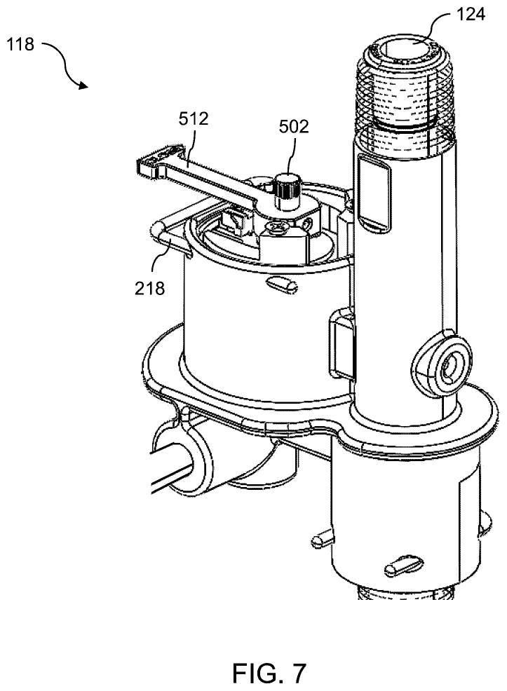

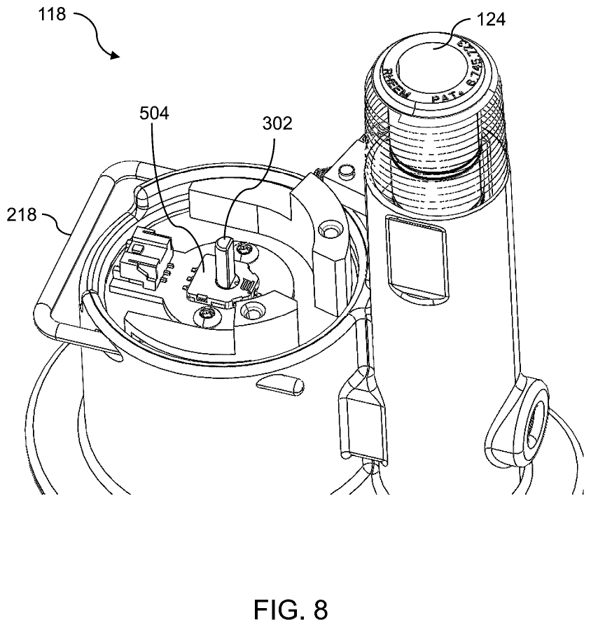

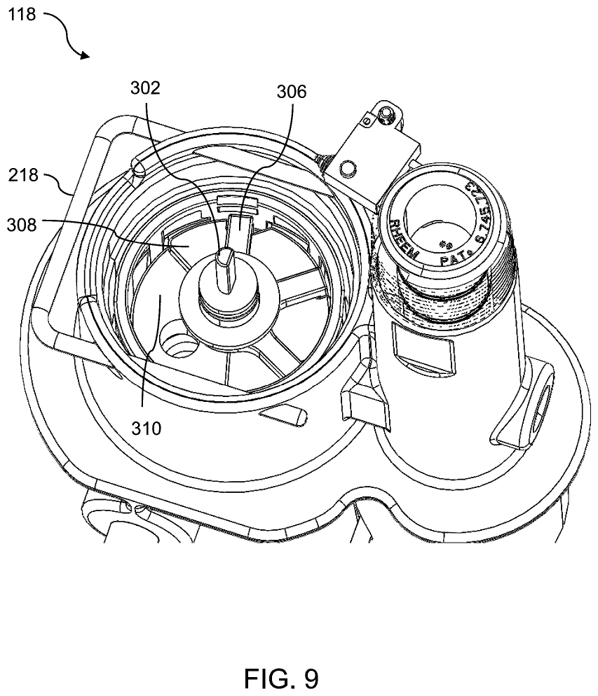

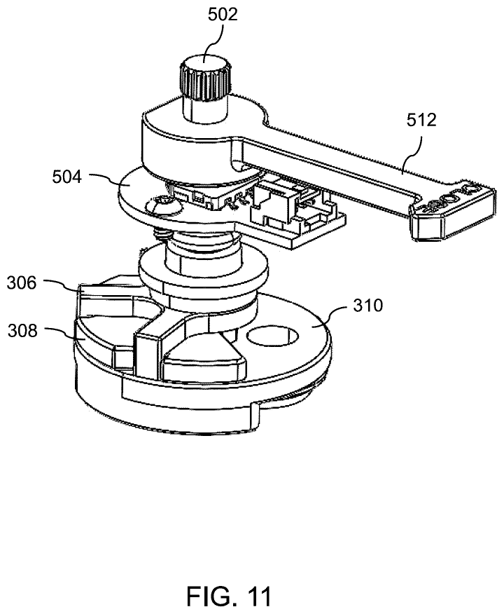

Additional example views of the valve 118 are shown in FIGS. 6-11. Specifically, FIG. 6 depicts a view of the valve 118 with the actuator 126 and the retainer clip 130 removed. FIG. 7 depicts a view of the valve 118 with the bracket 128 removed. FIG. 8 depicts a view of the valve 118 with the drive spline 502 removed. FIG. 9 depicts a top view of the valve stack 204, and FIG. 10 depicts a top view of the shell 314. FIG. 11 depicts an isometric view of a “connected” state of the drive spline 502, the position sensor 504, the retainer disc 306, the upper disc 308 and the lower disc 310.

As described above, the valve assembly 102 may further include the mixer 120 that may be connected with the valve 118 via the shunt 122 and configured to receive the cold water from the valve 118 via the shunt 122. The mixer 120 may be further connected with the storage tank 104 and configured to receive the hot water (shown as hot water 220 in FIG. 2) from the storage tank 104 via a tank adapter 222. The mixer 120 may include a swirl mixing chamber 224 (or mixing chamber 224) that may be configured to mix/blend the cold water received from the valve 118 and the hot water 220 received from the storage tank 104 and output the blended water 116 to an outlet port 226 of the mixer 120.

The mixer 120 may further include a third temperature sensor 134 that may be configured to detect the water temperature of the blended water 116 (or blended water temperature). The third temperature sensor 134 may be communicatively coupled with the controller 112 and may share inputs associated with the blended water temperature with the controller 112 continuously or at a predefined frequency.

The controller 112 may be configured to obtain inputs from the first, second, third temperature sensors 108, 132, 134 and the leak detector 110 and generate command signals to be transmitted to the actuator 126 to cause axial rotation of the upper disc 308 relative to the lower disc 310 based on the obtained inputs and the desired water temperature. Stated another way, the controller 112 may be configured to generate and transmit the command signals to the actuator 126 to cause the valve 118 to operate in the first, second, third or fourth operating state described above, based on the obtained inputs and the desired water temperature. An example controller operation is described below.

In some aspects, the controller 112 may be configured to determine a presence of water leak in the storage tank 104 (or other system components) based on the inputs obtained from the leak detector 110. Responsive to determining the presence of water leak, the controller 112 may cause, via the actuator 126, the valve 118 to operate in the fourth operating state. Stated another way, responsive to determining the presence of water leak, the controller 112 may cause the valve 118 to completely shut off the supply of cold water to both the mixer 120 and the storage tank 104. In this case, the controller 112 may generate and transmit command signals to the actuator 126 to cause axial rotation of the upper disc 308 on the lower disc 310 such that both the through-holes 334a and 334c may be blocked by the body of the upper disc 308, as shown in the view 408 of FIG. 4.

On the other hand, responsive to determining that there is no water leak in the storage tank 104 (or other system components) based on the inputs obtained from the leak detector 110, the controller 112 may cause the valve 118 to enable a flow of cold water into the storage tank 104 and/or the mixer 120. Stated another way, responsive to determining that there is no water leak in the storage tank 104 (or other system components) based on the inputs obtained from the leak detector 110, the controller 112 may cause the valve 118 to operate in the first, second or third operating state. In some aspects, the controller 112 may cause the valve 118 to operate in the first, second or third operating state based on the hot water temperature (i.e., the water temperature of the hot water stored in the storage tank 104 detected by the first temperature sensor 108), the cold water temperature (i.e., the water temperature of the cold water 114 received from the inlet port 124 detected by the second temperature sensor 132), the blended water temperature (i.e., the water temperature of the blended water 116 output from the mixer 120 detected by the third temperature sensor 134), and the desired water temperature set by the system user.

In an exemplary aspect, the controller 112 may cause the valve 118 to operate in the first operating state when the hot water temperature may be equivalent to the desired water temperature that the system user requires. Stated another way, the controller 112 may cause the valve 118 to transfer the cold water 114 fully to the storage tank 104 (and not transfer any cold water to the mixer 120) when the controller 112 determines that the hot water temperature may be equivalent to the desired water temperature. In this case, the controller 112 may generate and transmit command signals to the actuator 126 to cause axial rotation of the upper disc 308 on the lower disc 310 such that the through-hole 334c may be exposed to the incoming cold water entering the valve stack 204 and the through-hole 334a may be blocked by the body of the upper disc 308, as shown in the view 402 of FIG. 4.

Further, the controller 112 may cause the valve 118 to operate in the third operating state when the hot water temperature may be substantially greater than the desired water temperature. Stated another way, the controller 112 may cause the valve 118 to transfer the cold water 114 fully to the mixer 120 (and not transfer any cold water to the storage tank 104) when the controller 112 determines that the hot water temperature may be substantially greater than the desired water temperature. In this case, the controller 112 may generate and transmit command signals to the actuator 126 to cause axial rotation of the upper disc 308 on the lower disc 310 such that the through-hole 334a may be exposed to the incoming cold water entering the valve stack 204 and the through-hole 334c may be blocked by the body of the upper disc 308, as shown in the view 406 of FIG. 4.

Furthermore, the controller 112 may cause the valve 118 to operate in the second operating state when the hot water temperature may be greater (but not substantially greater) than the desired water temperature. In some aspects, when the valve 118 operates in the second operating state, the controller 112 may be further configured to determine an “optimal” portion of the cold water received from the inlet port 124 to be transferred to the mixer 120 based on the hot water temperature, the blended water temperature, the cold water temperature, and the desired water temperature. The controller 112 may determine the optimal portion of the cold water such that the blended water temperature becomes equivalent to the desired water temperature. For example, the controller 112 may determine that 60% of the cold water received from the inlet port 124 should be transferred to the mixer 120 (and remaining 40% to the storage tank 104) based on the hot water temperature, the cold water temperature, the blended water temperature and the desired water temperature, to cause the blended water temperature to become equivalent to the desired water temperature.

In some aspects, the controller 112 may be a proportional-integral-derivative (PID) or proportional-integral (PI) controller that may utilize a closed-loop feedback control mechanism that continuously adjusts outputs (e.g., the optimal portion of the cold water described above) based on the real-time measured hot water temperature, the blended water temperature, and the cold water temperature. For example, if the real-time measured hot water temperature indicates that the temperature of the water stored in the storage tank 104 is gradually decreasing, the controller 112 may reduce the amount of cold water to be transferred to the mixer 120 so that the blended water temperature stays equivalent to the desired water temperature. It may be appreciated that during a hot water demand event when hot water is being drawn from the storage tank 104, the hot water temperature may change over time. Based on the real-time feedback from the first temperature sensor 108, the controller 112 may adjust the portion of water to be transferred to the mixer 120 to continue to discharge water at the desired water temperature.

Responsive to determining the optimal portion of the cold water, the controller 112 may cause the valve 118 to transfer the determined optimal portion of the cold water to the mixer 120. Specifically, in this case, the controller 112 may generate and transmit command signals to the actuator 126 to cause axial rotation of the upper disc 308 on the lower disc 310 so that the “opening percentage” of each through-holes 334a and 334c is such that the determined optimal amount of cold water flows from the valve 118 to the mixer 120 (and remaining cold water flows to the storage tank 104), as shown by the view 404 of FIG. 4.

In some aspects, the valve 118 operates in the fourth operating state whenever a water leak is detected in the storage tank 104 by the leak detector 110, irrespective of the values of the hot water temperature, the cold water temperature, the blended water temperature and the desired water temperature. Stated another way, the valve 118 operates in the first, second or third operating states described above only when no water leak is detected by the leak detector 110. The valve 118 completely shuts off the supply of cold water to the mixer 120 and the storage tank 104 in the fourth operating state to prevent any damage to the system components because of the water leakage.

A person ordinarily skilled in the art may appreciate that since a mixing valve is typically disposed at the “hot side” of a conventional water heating system (e.g., at a point where the hot water from the storage tank mixes with the cold water from the inlet), the mixing valve of a conventional water heating system is not equipped to completely shut-off the supply of cold water from the inlet into the storage tank in the event of a water leakage. Therefore, in some cases, a conventional water heating system may require two separate valves to operate optimally: one valve for mixing hot and cold water and a second valve for shutting off the supply of cold water in the event of a water leakage. On the other hand, in the case of the system 100, since the valve 118 is disposed at the “cold side” of the system 100 (i.e., at the inlet port 124 that transfers the cold water 114 to the valve 118) and controls the flow of cold water towards the mixer 120 and the storage tank 104 simultaneously, the valve 118 is able to enable the operations of water mixing and shutting off the water supply within a single valve.

Further, it may be appreciated from the description above that since the “moving parts” of the valve 118 (i.e., the upper disc 308 and the lower disc 310) are disposed on the “cold side” of the system 100 (i.e., at the inlet port 124 that transfers the cold water 114 to the valve 118) and not on the “hot side” of the system 100 (i.e., at a point where the hot water from the storage tank 104 is received), the valve 118 experiences considerably less scaling and structural degradation over time. A person ordinarily skilled in the art may appreciate if the valve 118, including the upper disc 308 and the lower disc 310, would have been disposed at the “hot side” of the system 100, the valve 118 would have experienced considerable scaling over time, and the hot water received from the storage tank 104 would have degraded the structural integrity of the valve 118. The system 100 alleviates this issue by having the valve 118 disposed at the “cold side” of the system 100, thus considerably increasing the life of the valve 118.

In some aspects, the controller 112 may be further configured to “verify” the operations of the actuator 126, the shaft 302, etc. by obtaining inputs from the positon sensor 504 continuously or at a predefined frequency. Based on the inputs obtained from the positon sensor 504, the controller 112 may verify whether the real-time axial position of the shaft 302 is equivalent to the intended or desired position of the shaft 302 as instructed by the controller 112 in the first, second, third or fourth operating state of the valve 118. Responsive to determining that the real-time axial position of the shaft 302 is different from the intended or desired position of the shaft 302 based on the inputs obtained from the positon sensor 504, the controller 112 may determine that the actuator 126, the shaft 302, and/or one or more additional valve components (e.g., components of the valve stack 204 and/or the actuator assembly 206) may be malfunctioning. In this case, the controller 112 may perform one or more remedial actions, e.g., transmit an error notification to a user device associated with the system user, output the error notification on a system's user interface, adjust the hot water temperature to become equivalent to the desired water temperature, and/or the like.

In some aspects, the valve assembly 102 may additionally include foam structures or foam dams 136a, 136b that may be attached to the bodies of the mixer 120 and the valve 118. The foam dams 136a, 136b may be insulated plates that may enable secure attachment of the valve assembly 102 (specifically the mixer 120 and the valve 118) to the housing 106. The foam dams 136a, 136b may be of any shape, and the example shapes of the foam dams 136a, 136b depicted in FIG. 1 should not be construed as limiting. Further, in alternative aspects, the valve assembly 102 may not include the foam dams 136a, 136b.

In additional aspects, the valve 118 may include one or more insulating “rings” that may be used to prevent leakage of water as the cold water flows through the various valve components. For example, the actuator mount structure 344 may include a first O-ring 346 (shown in FIG. 3) wrapped around the actuator mount structure circumference, which may prevent water leakage between the actuator mount structure 344 and the valve 118 body. The first O-ring 346 seals the actuator mount structure 344 to the valve 118 body. The valve 118 may further include a second O-ring 348 wrapped around the shaft 302, which may prevent water leakage between the shaft 302 and the actuator mount structure 344.

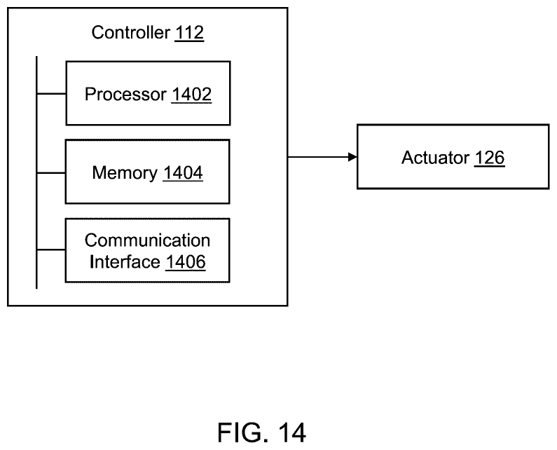

FIG. 14 depicts a block diagram of the controller 112 in accordance with one or more embodiments of the present disclosure. The controller 112 may include a plurality of components including, but not limited to, a processor 1402, a memory 1404, and a communication interface 1406. The controller 112 may be a computing device configured to receive data, determine actions based on the received data, and output a control or command signal instructing one or more water heating system components (e.g., the actuator 126) to perform one or more actions. In some aspects, the controller 112 may be configured to receive the inputs from the first, second, third temperature sensors 108, 132, 134, the leak detector 110, etc., as described above.

In some aspects, the controller 112 may be configured to send and receive wireless or wired signals, and the signals may be analog or digital signals. The wireless signals may include Bluetooth™, BLE, WiFi™, ZigBee™, infrared, microwave radio, or any other type of wireless communication signals as may be suitable for a particular water heating system application. The hard-wired signals can include communication signals between any directly wired connections between the controller 112 and other water heating system components. For example, the controller 112 can be hard-wired to the first, second, and third temperature sensors 108, 132, 134 and the leak detector 110.

Alternatively, the controller 112 may communicate with the first, second, and third temperature sensors 108, 132, 134 and the leak detector 110 via a digital connection. The digital connection can include a connection such as an Ethernet or a serial connection and can utilize any suitable communication protocol for the water heating system application, such as Modbus, fieldbus, PROFIBUS, SafetyBus, Ethernet/IP, and/or the like. Furthermore, the controller 112 can utilize a combination of wireless, hard-wired, and analog or digital communication signals to communicate with and control the various water heating system components. A person ordinarily skilled in the art may appreciate that the above configurations are given merely as non-limiting examples and the actual configuration can vary depending on the particular water heating system application.

The memory 1404 may be configured to store a program and/or instructions associated with the functions and methods described herein. The processor 1402 may be configured to execute the program and/or instructions stored in the memory 1404. The memory 1404 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory 1404.

The communication interface 1406 may be configured to send or receive communication signals between the various water heating system components (e.g., the first, second, third temperature sensors 108, 132, 134, and the leak detector 110). The communication interface 1406 can include hardware, firmware, and/or software that allows the processor 1402 to communicate with the other components via wired or wireless networks, whether local or wide area, private or public, as known in the art. The communication interface 1406 can also provide access to a cellular network, the Internet, a local area network, or another wide-area network as suitable for the particular water heating system application.

Additionally, the controller 112 may have or be in communication with a user interface (not shown) for receiving inputs from the user (e.g., the desired water temperature described above). The user interface may be installed locally on the system 100.

The operation of the controller 112 is described above in conjunction with FIG. 1 and hence not described again here for the sake of simplicity and conciseness.

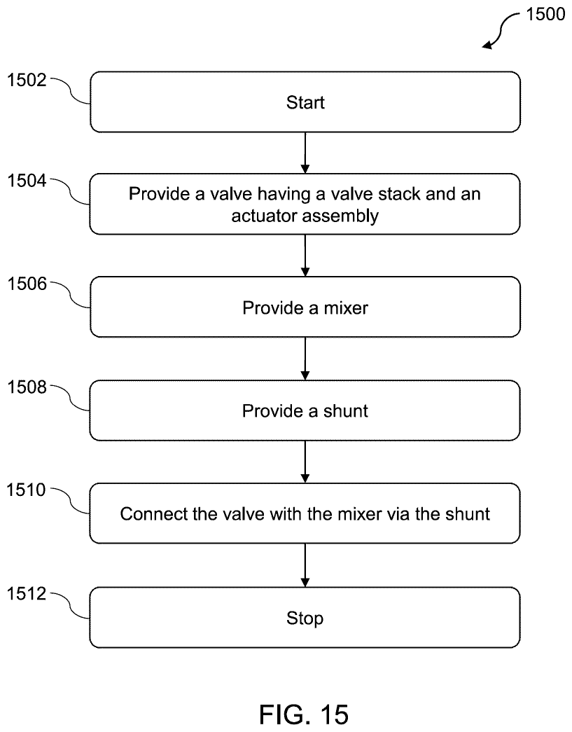

FIG. 15 depicts a flow diagram of a method 1500 to make the valve assembly 102 in accordance with one or more embodiments of the present disclosure. FIG. 15 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 1500 starts at step 1502. At step 1504, the method 1500 may include providing the valve 118 with the valve stack 204 and the actuator assembly 206. At step 1506, the method 1500 may include providing the mixer 120. At step 1508, the method 1500 may include providing the shunt 122. At step 1510, the method 1500 may include connecting the valve 118 with the mixer 120 via the shunt 122.

The method 1500 stops at step 1512.

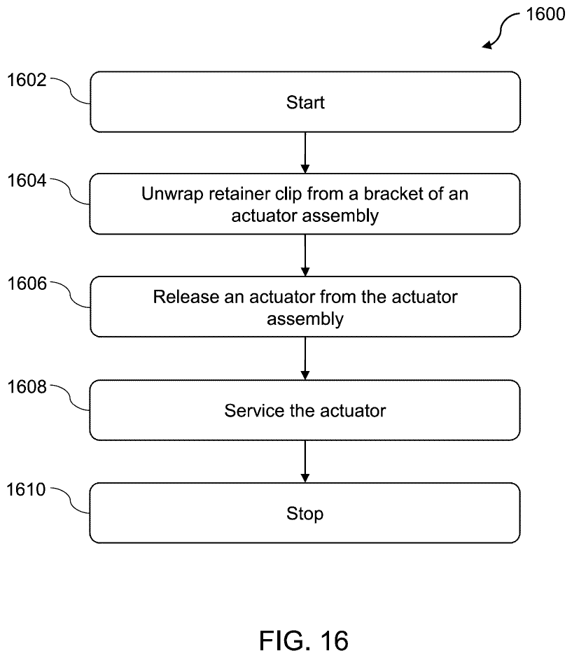

FIG. 16 depicts a flow diagram of a second method 1600 for servicing the actuator 126 in accordance with one or more embodiments of the present disclosure. FIG. 16 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 1600 starts at step 1602. At step 1604, the method 1600 may include removing or unwrapping the retainer clip 130 from the bracket 128. At step 1606, the method 1600 may include releasing the actuator 126 from the bracket 128. At step 1608, the method 1600 may include servicing the actuator 126.

The method 1600 stops at step 1610.

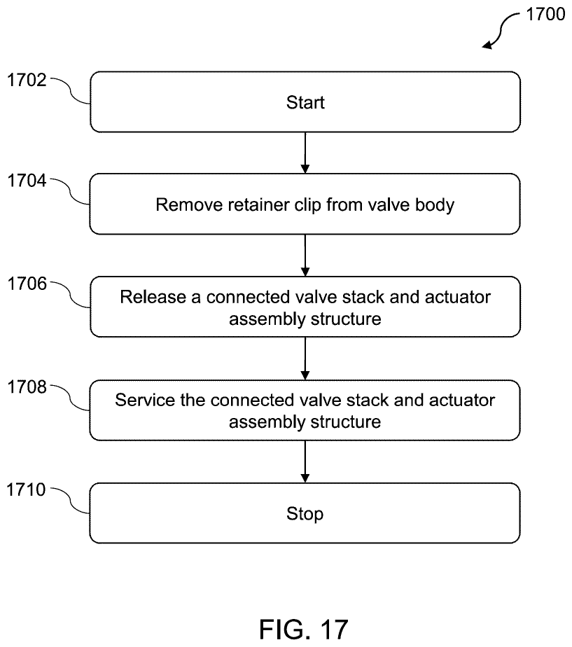

FIG. 17 depicts a flow diagram of a third method 1700 for servicing the combined or connected valve stack and actuator assembly structure 1302 in accordance with one or more embodiments of the present disclosure. FIG. 17 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 1700 starts at step 1702. At step 1704, the method 1700 may include removing the insertion clip 218 from the valve body, as shown in FIG. 13. At step 1706, the method 1700 may include releasing the connected valve stack and actuator assembly structure 1302. At step 1708, the method 1700 may include servicing the connected valve stack and actuator assembly structure 1302 or the valve stack 204/any other component of the valve 118.

The method 1700 stops at step 1710.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A valve, comprising:
an inlet port configured to receive a supply of cold water;
a valve stack configured to receive the cold water from the inlet port, wherein the valve stack comprises:
a first disc and a second disc, wherein the first disc is configured to axially rotate relative to the second disc; and
a shaft connected to the first disc; and
an actuator assembly comprising an actuator connected to the first disc via the shaft, wherein the actuator is configured to cause an axial rotation of the first disc relative to the second disc, and
wherein the valve stack is configured to control a flow of cold water to at least one of a first external component or a second external component based on a position of the first disc relative to the second disc when the first disc is axially rotated.

2. The valve of claim 1, wherein the cold water is received from the inlet port on a top surface of the first disc, and wherein the second disc comprises one or more through-holes.

3. The valve of claim 2, wherein the valve stack is configured to enable the flow of cold water fully to the first external component, fully to the second external component, partially to the first external component and partially to the second external component, or completely shut off the flow of cold water to both the first external component and the second external component based on a relative alignment of the one or more through-holes with the first disc when the first disc is axially rotated by the actuator.

4. The valve of claim 1, wherein a bottom planar surface of the first disc contacts a top planar surface of the second disc.

5. The valve of claim 1, wherein the valve is part of a water heating system comprising a mixer and a water tank, and wherein the first external component is the mixer and the second external component is the water tank.

6. The valve of claim 5, wherein the water heating system further comprises a shunt, wherein the valve is connected with the mixer via the shunt.

7. The valve of claim 6, wherein the water tank is configured to store hot water, and wherein the mixer is connected with the water tank and configured to receive the hot water from the water tank.

8. The valve of claim 7, wherein the mixer comprises a mixing chamber configured to blend the cold water received from the valve and the hot water received from the water tank and output a blended water to an outlet port of the mixer.

9. The valve of claim 8, wherein the water heating system further comprises a controller communicatively coupled with the actuator, and wherein the actuator is configured to cause axial rotation of the first disc based on command signals received from the controller.

10. The valve of claim 9, further comprising a first temperature sensor configured to detect a water temperature of the cold water,
wherein the mixer further comprises a second temperature sensor configured to detect a water temperature of the blended water, wherein the first temperature sensor and the second temperature sensor are communicatively coupled with the controller, and wherein the controller is configured to generate the command signals based on inputs obtained from the first temperature sensor, the second temperature sensor, a desired water temperature and a hot water temperature of the hot water stored in the water tank.

11. The valve of claim 1, wherein the actuator is removably connected with the actuator assembly via a first removable connection means, wherein the first removable connection means is configured to enable a user to remove the actuator from the actuator assembly in a tool-less manner.

12. The valve of claim 1, wherein the actuator assembly further comprises a bracket and a retainer clip, wherein the actuator is configured to be attached to the bracket via the retainer clip, and wherein the bracket is configured to be connected to the valve stack.

13. The valve of claim 12, further comprising an actuator mount structure, and wherein the bracket is connected to the valve stack via the actuator mount structure.

14. The valve of claim 1, wherein the actuator assembly further comprises a position sensor, wherein the actuator is connected to the shaft via the position sensor, and wherein the position sensor is configured to detect a real-time axial position of the shaft.

15. The valve of claim 1, wherein the actuator assembly further comprises a drive spline, and wherein the actuator is connected to the shaft via the drive spline.

16. The valve of claim 1, wherein the actuator is a motor.

17. A valve assembly, comprising:
a valve comprising:
an inlet port configured to receive a supply of cold water;
a valve stack configured to receive the cold water from the inlet port, wherein the valve stack comprises:
a first disc and a second disc, wherein the first disc is configured to axially rotate relative to the second disc; and
a shaft connected to the first disc; and
an actuator assembly comprising an actuator connected to the first disc via the shaft, wherein the actuator is configured to cause an axial rotation of the first disc relative to the second disc;
a mixer in fluid communication with the valve and an external water tank configured to store hot water, wherein the mixer is configured to receive the hot water from the external water tank; and
a shunt,
wherein the valve is connected with the mixer via the shunt, wherein the valve stack is configured to control a flow of cold water to at least one of the mixer or the external water tank based on a position of the first disc relative to the second disc when the first disc is axially rotated, wherein the valve is configured to supply the flow of cold water to the mixer via the shunt, and wherein the mixer is configured to blend the cold water received from the valve and the hot water received from the external water tank and output a blended water.

18. The water heating system of claim 17, wherein the actuator assembly further comprises a bracket and a retainer clip, wherein the actuator is configured to be attached to the bracket via the retainer clip, and wherein the bracket is configured to be connected to the valve stack.

19. The water heating system of claim 17, wherein the actuator assembly further comprises a drive interface, and wherein the actuator is connected to the shaft via the drive interface.

20. A water heating system, comprising:
a water tank configured to store hot water;
a valve comprising:
an inlet port configured to receive a supply of cold water; and
a valve stack configured to receive the cold water from the inlet port, wherein the valve stack comprises:
a first disc and a second disc in contact with each other, wherein the first disc is configured to axially rotate relative to the second disc; and
a shaft connected to the first disc; and
an actuator assembly comprising an actuator connected to the first disc via the shaft, wherein the actuator is configured to cause an axial rotation of the first disc relative to the second disc;
a mixer in fluid communication with the valve and the water tank, wherein the mixer is configured to receive the hot water from the water tank; and
a shunt,
wherein the valve is connected with the mixer via the shunt, wherein the valve stack is configured to control a flow of cold water to at least one of the mixer or the water tank based on a position of the first disc relative to the second disc when the first disc is axially rotated, wherein the valve is configured to supply the flow of cold water to the mixer via the shunt, and wherein the mixer is configured to blend the cold water received from the valve and the hot water received from the water tank, and output a blended water.
